(19) United States
(12) Patent Application Publication
(10) Pub. No.: US 2005/0154128 A1
(43) Pub. Date: Jul. 14, 2005

(54) Polyolefin composition having dispersed nanophase and method of preparation

(76) Inventors: Richard M. Kopchik, Southampton, PA (US); Michael Bailey, Aston, PA (US); John O. Bieser, Houston, TX (US); Gary Ceska, Exton, PA (US); William R. Dougherty, Lancaster, PA (US)

Correspondence Address: COZEN O'CONNOR, P.C., 1900 MARKET STREET, PHILADELPHIA, PA, 19103-3508, US

(21) Appl. No.: 10/996,744

(22) Filed: Nov. 24, 2004

Related U.S. Application Data
(60) Provisional application No. 60/525,173, filed on Nov. 26, 2003.

(51) Int. Cl. C08L 51/04

(52) U.S. Cl. 525/71

(57) ABSTRACT

A polyolefin composition comprising a discontinuous polymer phase dispersed in a continuous polyolefin phase is disclosed. The discontinuous polymer is polymerized by a method comprising reacting a blend or mixture of the polyolefin and one or more polyethylenically unsaturated monomers in the presence of a free radical initiator. Articles and materials made from he composition exhibit several advantageous properties as compared to the corresponding unmodified polyolefins, for example printability, paintability, and dyeability in the case of spun fiber, sheets, automotive applications such as interior parts and bumpers; toughness and abrasion resistance in the case of flooring, and impact strength in the case of siding.

### CROSS-REFERENCE TO RELATED APPLICATION

Benefit of Provisional Application Ser. No. 60/525,173, filed Nov. 26, 2003 is claimed.

### BACKGROUND OF THE INVENTION

This invention relates to the field of polymer compositions, manufacture, and use thereof. In particular the invention relates to polyolefin compositions.

Polyolefins have been used widely in various applications due to their low cost. However, certain properties such as paintability, dimensional stability, biodegradability, and solvent resistance are deficiencies for which extensive research has been conducted to overcome. Among the various attempts to impart such properties in polyolefins are reactive extrusion methods of preparing inverse phase blends of poly(ethylene oxide) and polyolefins as disclosed in U.S. Pat. Nos. 6,225,406 and 5,912,076 and reactive extrusion of polyolefins and hydrophobic coagents such as hydrophobic acrylates as reported by B. K. Kim, in Korea Polymer Journal (1996), 4(2), 215-226. Among the coagents disclosed by Kim are trimethylol propane triacrylate, pentaerythritol triacrylate, trially isocyanurate, and p-benzoquinone.

In spite of the extensive research and attempts by others to solve these problems, further improvements would be very desirable, especially with respect to paintability and biodegradability properties. The present invention addresses those problems and presents improved compositions and methods for manufacture and use.

Simpson, et al., U.S. Pat. No. 6,111,013, disclose making a plastics product from a polyolefin resin comprising incorporating a plasticizer monomer system which is substantially non-polymerisable under extrusion, spread-coating or calendaring, conditions used in the manufacturing process and which acts as a plasticizer or processing aid under shape forming conditions, while being substantially polymerisable by subsequently inducing polymerization of said plasticizer monomer so as to provide a final product substantially free of liquid plasticizer. Stearyl methacrylate and trimethylolpropane trimethacrylate were Simpson et al's preferred and exemplified plasticizers.

In view of the various deficiencies in the prior art compositions and methods, it is an object of the present invention to provide improved polyolefin compositions and methods of preparing and using them.

### SUMMARY OF THE INVENTION

In one aspect the invention is a composition a continuous polyolefin phase and a discontinuous nanoparticulate dispersion of a polymer of a monomer system comprising an acrylic monomer.

Another aspect of the invention is a method comprising mixing or blending of a polyolefin and a monomer system comprising an acrylic monomer and polymerizing the monomer system in the presence of a free radical catalyst under conditions so as to form a discontinuous nanoparticulate dispersion in a continuous phase of the polyolefin.

The invention, in another aspect, is the resultant two phase polymer system having uniformly dispersed nanoparticles in a continuous polyolefin matrix.

Yet another aspect is a method of using the two phase polymer system and articles comprising such polymer.

### BRIEF DESCRIPTION OF THE DRAWINGS

FIG. 1 is a photo of a filament of the invention after exposure to dye.

FIG. 2 is a photo of a second filament of the invention after exposure to dye

FIG. 3 is a graphical representation of data showing the effect of acrylate level on flexural modulus.

FIG. 4 is a photomicrograph of the morphology of a less preferred embodiment of a composition according to the invention.

FIG. 5 is a photomicrograph of the morphology of a preferred embodiment of a composition according to the invention.

### DETAILED DESCRIPTION

The composition of the invention, as mentioned, comprises a discontinuous nanoparticulate dispersion of a polymer of a monomer system comprising an acrylic monomer in a continuous polyolefin phase. The nanoparticulate phase polymer preferably comprises about 1 to 99 percent and the polyolefin phase about 99 to 1 percent by weight based on combined weight of the two phases. Preferably the discontinuous phase comprises about 5 to 50 percent on the same basis. The composition is a form of thermoplastic vulcanazate (TPV).

The monomers in the monomer system are not limited to acrylic monomers. Other ethylenically unsaturated monomers, for example styrene, can be used alone or in combination as long as the conditions can be adjusted so that the novel discontinuous nanoparticulate dispersion results. The average particle size of the dispersion can vary depending on desired properties and the particular polyolefins, ratio of monomer system to polyolefin, initiator, and reaction conditions, but it is preferred that the average particle size be in the nano range, usually about 2 to 500 on average, and preferably about 2 to 400, and more preferably 2 to 300 nanometers. The distribution of particle sizes is usually fairly narrow, and narrower distributions with smaller average particle sizes are preferred for many applications. The more preferred compositions have a distribution such that 90% by weight of the particles have a maximum particle size of 50 nm.

Preferred monomers include 2-(2-ethoxyethoxy) ethyl acrylate, diethylene glycol diacrylate, tridecyl acrylate, tridecylacrylate hexanediol diacrylate, lauryl acrylate, alkoxylated lauryl acrylate, caprolactone acrylate, 1,6-hexanediol diacrylate, trimethylolpropane triacrylate, polyethylene glycol diacrylate, neopentane diol diacrylate, and polyethylene glycol diacrylate. When the monomer system comprises polyfunctional monomers, the dispersed polymer will be crosslinked. A preferred monomer system comprising polyfunctional monomers comprises 50% by weight tridecyl acrylate, 35-45% by weight caprolactone acrylate, and 5-15% by weight polyethylene glycol diacrylate.

The composition is preferably prepared by introducing the polyolefin and the monomer system into a batch mixer, continuous mixer, single screw extruder, or twin screw extruder, forming a homogeneous mixture or solution, introducing a free radical catalyst, and providing pressure and temperature conditions so as to polymerize the monomer system and form a separate, dispersed nanoparticulate polymer phase in a continuous polyolefin phase.

In many cases it is most efficient to conduct the polymerization in a twin screw extruder.

The composition of the invention is flowable and indeed has the same or similar melt viscosity as the corresponding polyolefin itself. Although the composition is two phase with a discontinuous phase which is often crosslinked, it flows as if it was a single phase thermoplastic polyolefin. The internal discontinuous phase appears under electron microscopy to be a nano system dispersed in the polyolefin.

The composition can be used to form a wide variety of materials and articles, for example fiber, sheet, film, or molded articles, which, depending on the particular system, have improved paintability, printability, biodegradability, wettability, tensile strength, impact strength, modulus, vapor transmission, thermoform processability, compatibility with fillers, compatibility in polymer blends, fire resistance, abrasion resistance, transparency, conductivity, and/or resistance to photodegredation as compared to the polyolefin which comprises the continuous polyolefin phase. Certain embodiments of the compositions have excellent paintability and biodegradability. Certain embodiments have improved dimensional stability and solvent resistance as compared to the polyolefin alone.

The monomers in the monomer system can be hydrophilic or hydrophobic. Preferred hydrophilic monomers are those having oxygen or nitrogen atoms and optionally halogens in their backbone structure. Examples of preferred hydrophilic monomers are ethers or polyether (meth)acrylates, which are polar materials and offer excellent resistance to non-polar solvents (e.g., hexane), as well as bases, and oxidizing and reducing agents. Ethoxylated and propoxylated monomers generally are more polar than their parent analogs because of the sequential addition of ethoxy or propoxy groups. In general, increasing moles of alkoxylation result in more hydrophilic monomers. Specific examples of hydrophilic (meth)acrylates are 2-(2-ethoxyethoxy) ethyl acrylate, tetrahydrofufuryl acrylate, polyethylene glycol (200) diacrylate, tetraethylene glycol diacrylate, triethylene glycol diacrylate, tripropylene glycol diacrylate, and polyethylene glycol (400) diacrylate.

In embodiments comprising one or more hydrophobic acrylic monomers in addition to the one or more hydrophilic acrylic monomers, the ratio of hydrophilic to hydrophobic monomers can be 1:100 to 100:1 by weight, preferably 40:60 to 60:40 by weight, and it is also preferred that at least one of the monomers be polyfunctional, most preferably difunctional.

Suitable polyolefins are polyethylene(PE), isotactic polypropylene (PP), syndiotactic PP, PE/PP, and PP/EPR (ethylene-propylene rubber). Also, mixtures of PP and EP, propylene-ethylene-ethylene vinyl acetate copolymer, propylene-ethylene-ethylene methyl acrylate copolymer, and propylene-ethylene-ethylene acrylic acid copolymer. Copolymers of ethylene and or propylene with alpha olefins, for example 1-butene, 1-hexane, and 1-octene, can also be used as the polyolefins. Blends of two or more polyolefins are suitable. PP is the preferred polyolefin. The polyolefin can be prepared by any method, but metallocene polyolefins are preferred.

The composition is prepared from a blend of the polyolefin with the monomer system. A free radical initiator can be added at any point in the process, for example in an extruder at a downstream point from where the monomers are added. The radical initiator can be any, but peroxides are most preferred. The preferred ratio of polyolefin to acrylic monomer(s) is about 50:50 to 99:1 by weight. Preferably at least 1% by weight of the blend is hydrophilic monomer(s).

Although in most cases the nanoparticulate dispersion is of one polymer, the nanoparticulate dispersion may include one or more additional, different dispersed polymers of different monomer systems comprising an acrylic monomer, the different polymers having differing Tg's, different polarities, different moduluses, and/or different impact strengths. Such compositions could be made by blending two different dynamically polymerized P/M (polymer/monomer) samples. For example making a high Tg acrylic in sPP sample and a low Tg acrylic in sPP sample and then extruder blending the two materials. Alternatively such a material could be made in a single extrusion operation by having two distinct reaction zones. In the first the low Tg monomer could be added and polymerized and in the second the high Tg monomer could be added and polymerized. Out the end of such an extruder would come a material with two distinct types of nano-particles dispersed in the same continuous polyolefin phase. By using two (or more) different types of particles in the same polyolefin continuous phase, some beneficial physical properties such as high modulus combined with high impact strength may be possible. Also a broader range of paint adhesion may be obtained.

The peroxides and (meth)acrylates added during extrusion remain effective during processing, leading to a significant change in flow properties upon processing. After processing, the polymerized acrylates form discrete domains in the presence of polyolefins. The domain size is stabilized by the polyolefin and monomer system which is formed during the processing to afford strong adhesion at the interphase between polyolefins and monomers.

The resultant extrudate may be pelletized as it is being formed or after cooling.

Suitable polyolefins include polyolefin polymers, copolymers, and terpolymers prepared by any known polymerization technique, for example free radical, Ziegler-Natta, single-site catalysed (metallocene) and the like. The olefin hydrocarbon polymer chains may also be substituted by incorporation of functional monomers or by post-polymerization functionalization, for example. Copolymers of olefins and acidic monomers or polar monomers can be used. Polymers prepared by extruder reaction grafting of monomers, such as maleic anhydride, to non-functional polyolefins can be used as the polyolefin component of the blends. One or more polyolefins can be used.

Various inorganic and organic fillers and reinforcements, fire retardants, stabilizers, dyes and pigments, can be incorporated into the blend of polyolefin and acrylic monomer(s) comprising hydrophobic acrylic monomer(s) prior to reactive extruding.

Polymeric additives such as impact modifiers, processing aids, compatibilizers, blending aids, stabilizers, flame retardants, pigments, and texturing aids can also be incorporated into the blends. Gas inclusions, in the form of either open or close cell foam can also be part of the polyolefin system. This can be achieved both through the use of a chemical blowing agent or through the mechanical incorporation of air, or another gas, into the system.

### EXAMPLES

### Example 1

A filament was produced from a formulation based on an 8 melt flow rate metallocene polypropylene homopolymer containing approximately 15% cross-linked acrylate system. Since the sample was significantly vis-broken during processing, the overall melt flow rate for the sample was high compared to normal fiber grade resins. Filaments were collected and examined for dyeability.

Table 1 describes the resin samples that were processed and compared. Sample 1046-39-36, or the acrylate-containing material, was produced using the reactive extrusion method.

TABLE 1

| | | Melt Flow |
|---|---|---|
| | | Rate, |
| Example | Description | gm/10 min |
| 1A | 85% metallocene polypropylene | 115 |
| | homopolymer (8 melt flow rate)/14.625% | |
| | Sartomer Pro-6952 acrylate monomer | |
| | blend/0.375% Trigonox 301 peroxide | |
| | (3,6,9-triethyl-3,6,9- | |
| | trimethyl-1,4,7-triperoxonane) | |
| 1B (Control) | 100% metallocene | 23 |
| | polypropylene homopolymer | |

The fiber melt spinning conditions set forth in Table 2 were used in the collection of 45 denier continuous filament.

TABLE 2

| Parameter | Setting |
|---|---|
| Melt Temperature | 200 deg C. |
| Spinneret Type | 2 × 27 round, 0.6 mm × 1.2 mm L round hole |
| Throughput rate | 1.0 g/min/hole |
| Quench Temperature | 16 C. (60 F.) |
| Quench Air | 1.0 mbar |
| Godet #1, m/min | 150 |
| Godet #2, m/min | 200 |
| Draw Ratio | 1.3:1 |

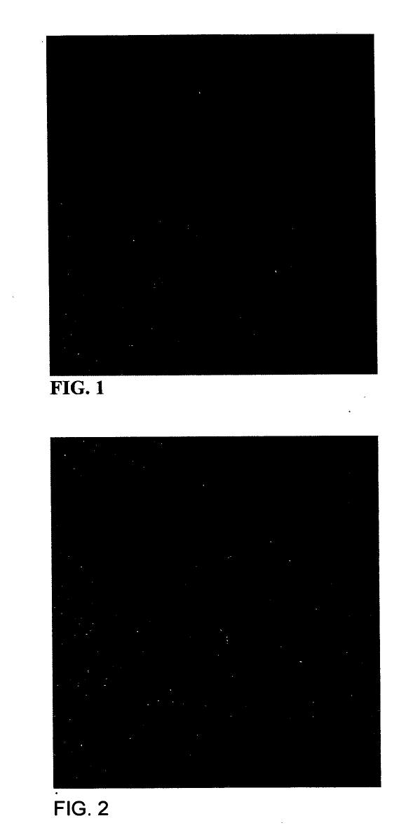

As a preliminary assessment of dyeability, filaments were exposed to a solution of 50% Rit Liquid Dye Blue Denim/50% water at 90 deg C. for 30 minutes. Filaments were then rinsed with water and compared for color pick-up. FIG. 1 (Comparative) shows the filaments of Example 1B, and FIG. 2 shows the filaments of Example 1A.

Surprisingly, even for an unoptimized P/M system, filament made from the invention, Example 1A, showed good textile dye pick-up and retention compared to the metallocene homopolymer polypropylene control, Example 1B. Thcompositions produced according to the invention can be used to make fabrics and fibers with improved properties such as dyeability, wettability, adhesion to polar materials, and biocidal characteristics, as well as resiliency performance of continuous filament used for carpet and upholstery.

### Example 2

The glass transition temperature, Tg, of the acrylate monomer used in a formulation was found to offer control over the modulus of cured P/M formulations. In the following examples 2B, 2C, 2D, and 2E representing the invention were compared to control 2A. In examples 2B and 2C, a low Tg acrylate blend of 50% tridecyl acrylate, 40% caprolactone acrylate, and 10% polyethylene glycol (400) diacrylate was introduced in a twin screw extruder along with Lupersol 101 brand 2,5-dimethyl-2,5-di(tert-butylperoxy)hexane free radical initiator with 85% or 70% by weight metallocene random polypropylene copolymer having a 12 melt flow rate. A room temperature Tg blend of 3EO neopentylglycol was used in Examples 2C and 2D with the same metallocene polypropylene random copolymer with 12 melt flow rate.

The weight ratios of ingredients are set forth in Table 3.

TABLE 3

| Sample | Description |
|---|---|
| 2A (control) | 100% metallocene random copolymer PP (12 melt flow rate) |
| 2B | 85% metallocene random copolymer PP (12 melt flow rate)/ |
| | 14.625% acrylate monomer blend of 50% tridecyl acrylate, 40% caprolactone |
| | acrylate, and 10% polyethylene glycol (400) diacrylate - Low Tg/ |
| | 0.375% Lupersol 101 peroxide (2,5-dimethyl-2,5-di(tert-butylperoxy)hexane) |
| 1046-39-43 | 70% metallocene random copolymer PP (12 melt flow rate)/ |
| | 29.4% acrylate monomer blend of 50% tridecyl acrylate, 40% caprolactone |
| | acrylate, and 10% polyethylene glycol (400) diacrylate - Low Tg/ |
| | 0.60% Lupersol 101 peroxide |
| 1046-39-59 | 85% metallocene random copolymer PP (12 melt flow rate)/ |
| | 14.775% 3EO neopentylglycol acrylate monomer blend - Room Temp Tg/ |
| | 0.225% Lupersol 101 peroxide |
| 1046-39-61 | 70% metallocene random copolymer PP (12 melt flow rate)/ |
| | 29.55% 3EO neopentylglycol acrylate monomer blend - Room Temp Tg/ |
| | 0.45% Lupersol 101 peroxide |

Table 4 shows compression molded physical properties for the formulations in the examples.

TABLE 4

| | Melt flow | Flex | Tensile | Tensile | | Tensile | |
|---|---|---|---|---|---|---|---|
| | rate | Modulus | Modulus | Yield | Elongation | Break | Elongation |
| Example | (gm/10 min) | (kpsi) | (kpsi) | (psi) | Yield (%) | (psi_{—} | Break (%) |
| 2A | 13.6 | 108.0 | 93.3 | 3272 | 9.8 | 4874 | 609 |
| 2B | 232 | 76.7 | 64.3 | 2701 | 13.9 | 3659 | 563 |
| 2C | 271 | 57.9 | 48.6 | 2275 | 15.6 | 2492 | 406 |
| 2D | 28 | 95.1 | 75.3 | 2911 | 12.3 | 3979 | 473 |
| 2E | 51 | 83.8 | 65.9 | 2805 | 14.2 | 3864 | 438 |

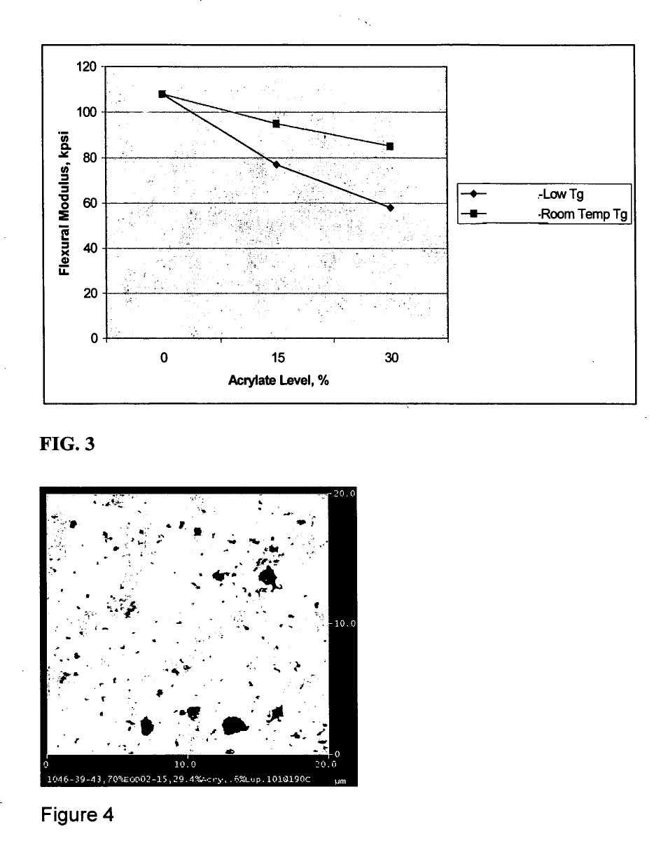

FIG. 3 is a graph which shows the effect of acrylate type and level on flexural modulus via Dynamic Mechanical Analysis (DMA) in formulations based on a 12 melt flow rate metallocene random copolymer. The low temperature Tg (flexible) monomer is a blend of 50% tridecyl acrylate, 40% caprolactone acrylate, and 10% polyethylene glycol (400) diacrylate). The Room Temp Tg monomer is diacrylate momomer (3EO neopentylglycol diacrylate).

Surprisingly, modulus properties of P/M formulations can be controlled by the Tg of acyrlate monomers. For f-PVC replacement, or other low modulus applications, target flexibility can be achieved by the addition of low modulus acrylate monomers. Room temperature Tg acrylate has relatively small effect on modulus. In addition, sheet or film made with room temperature Tg monomer exhibits more “dead fold”, or conformability compared to unmodified materials. As a speculation, the use high Tg acrylate monomer would result in cured formulations with very high modulus.

### Example 3

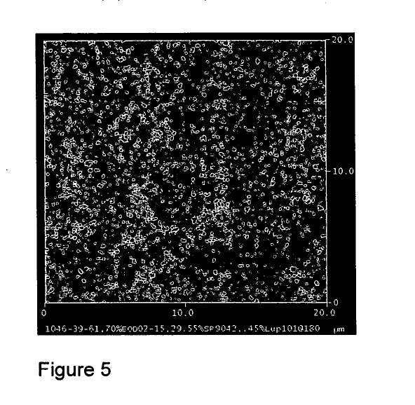

The degree of acrylate monomer functionality, as defined by the number of acrylate sites per monomer used in a formulation, was found to offer control over the morphology of cured P/M formulations. Composition morphologies are established via Atomic Force Microscopy (AFM) images shown in FIG. 5.

In general, the morphologies of P/M formulations formed during the reactive extrusion method used in the experiments showed a majority of well dispersed, small (<1 micron) polyacrylate particles within the polyolefin host as evidenced in FIG. 1. Some larger particles could occur, however, the majority of particles were submicron, with a large population on the nanoscale (arguably defined as <0.3 micron). In an interesting comparison of acrylate monomer type, the reactivity and dispersion of di-acrylate SR 9042 versus mono-acrylate Pro-5962 was pronounced. FIG. 5 shows the AFM images for approximately 30% acrylate dispersed in 70% metallocene random copolymer PP using a mono-acrylate system, and FIG. 1 hows the AFM images acrylate. Even though the mono-acrylate system showed reasonably good dispersion, the use of a di-acrylate with greater reactivity improved the dispersion and significantly reduced the particle size to <0.1 micron size. Table 5shows the formulations used in FIGS. 1 and 2, respectively.

TABLE 5

| Sample | Description |
|---|---|
| 3A | 70% metallocene random copolymer PP |
| | (12 melt flow rate)/29.4% blend of 50% |
| | tridecyl acrylate, 40% caprolactone acrylate, |
| | and 10% polyethylene glycol (400) |
| | diacrylate/0.60% Lupersol 101 peroxide |
| 3B | 70% metallocene random copolymer PP |
| | (12 melt flow rate)/29.55% 3EO |
| | neopentylglycol diacrylate/0.45% |
| | Lupersol 101 peroxide |

### Example 4

The effect of monomer level and type on the surface tension of compression molded plaques made from compositions prepared according to the invention was evaluated. Surprisingly, the invention formulations showed a permanent shift in the surface tension of molded plaques, indicating good wettability, paintability, and printability compared to unmodified polyolefins.

All types of polyolefin resins tested in different polyolefin formulations with 15% acrylate monomer (blend of 50% tridecyl acrylate, 40% caprolactone acrylate, and 10% polyethylene glycol (400) diacrylate) and above showed significant increases in surface tension. Table 6 shows the surface tension results for different formulations.

TABLE 6
Surface Tension of Formulations

| | | Surface Tension, |
|---|---|---|
| Resin Type | Acrylate Content, % | dyne/cm2 |
| syndiotactic PP | 0 | 34 |
| | 15 | 56 |
| metallocene random copolymer | 0 | 34 |
| | 15 | 56 |
| ZN homopolymer | 0 | 36 |
| | 15 | 51 |
| metallocene homopolymer | 30 | 52 |

### Example 5

The effect of polyolefin type on the properties of compression molded plaques made from formulations comprising metallocene random copolymer polypropylene resin resulted in significantly higher elongations compared to other polyolefin types including Ziegler Natta (ZN) homopolymer, metallocene homopolymer, and syndiotactic polypropylene.

Tensile strength properties of compression formulations of the invention comprising different polyolefin types generally changed to a similar degree for each respective acyrlate system. However, the elongational properties of formulations based on a 12 melt flow rate metallocene random copolymer polypropylene, were considerably higher than formulations made from any of the other polyolefins, including syndiotactic polypropylene. This finding shows that metallocene random copolymer polypropylene resins are preferred base materials for “soft” polypropylene formulations. The compression molded plaque properties were not significantly affected by the final melt flow rate of the respective formulation or degree of polyolefin vis-breaking that occurred for each formulation. Table 7 shows the high elongation properties found with random copolymers.

TABLE 7

| | | Elongation at |
|---|---|---|
| Example | Description | Break, % |
| 5A | 85% metallocene polypropylene homopolymer (8 melt flow rate)/ | 12 |
| | 14.775% blend of 50% tridecyl acrylate, 40% | |
| | caprolactone acrylate, and 10% polyethylene glycol (400) | |
| | diacrylate acrylate monomer blend/0.225% Trigonox 301 | |
| | peroxide | |
| 5B | 85% metallocene polypropylene homopolymer (10 melt | 17 |
| | flow rate)/14.700% blend of 50% tridecyl acrylate, 40% | |
| | caprolactone acrylate, and 10% polyethylene glycol (400) | |
| | diacrylate acrylate monomer blend/0.300% Trigonox 301 | |
| | peroxide | |
| 5C | 85% metallocene polypropylene random copolymer (8 melt | 514 |
| | flow rate)/14.775% blend of 50% tridecyl acrylate, 40% | |
| | caprolactone acrylate, and 10% polyethylene glycol (400) | |
| | diacrylate acrylate monomer blend/0.225% Lupersol 101 | |
| | peroxide | |

A wall covering material was produced from a formulation according to the invention based on a blend of organic components consisting of polyolefins and a blend of acrylic monomers, and inorganic components consisting of a blend of fillers. That composition is presented in Table 8.

TABLE 8
Organic (60 weight %) consisting of
Polymer (75 weight %)

| | | |
|---|---|---|
| sPP | 50 weight % | 22.5% of total |
| mPE | 50 weight % | 22.5% of total |

Monomer (25 weight %)

| | | |
|---|---|---|
| TDA | 15 weight % | 2.25% of total |
| CLA | 70 weight % | 10.5% of total |
| PEGDA | 15 weight % | 2.25% of total |
| Trig 301 | 3 weight % (based on monomer) | |

Inorganic (40 weight %) consisting of

| | | |
|---|---|---|
| ATH | 94.4 weight % | 37.78% of total |
| SPR | 2.9 weight % | 1.16% of total |
| TiO₂ | 2.7 weight % | 1.08% of total |

wherein
sPP = syndiotactic polypropylene with an MFR of 10
mPE = metallocene polyethylene plastomer with a MFR of 5
TDA = tridecyl acrylate
CLA = caprolactone acrylate
PEGDA = polyethylene glycol (400) diacrylate
Trig 301 = 3,6,9-triethyl-3,6,9-trimethyl-1,4,7-triperoxonane
ATH = aluminum trihydrate
SPR = silicon polymer resin
TiO₂ = titanium dioxide

The composition was prepared by blending the ingredients in a Farrel 250 continuous mixer. The ingredients were added in several streams to the mixing unit of the Farrel. The monomers and the initiator were combined and pumped into the mixer unit at about the half way point. The polymer were combined and added via a pellet feeder at the start of the mixing unit. The aluminum trihydrate was added with one powder feeder and a blend of the silicon polymer resin and the titanium dioxide was added with a second powder feeder, both feeding to the start of the mixing unit. The mixing zone temperature was set at 140° C. The feeds were adjusted to generate a product rate of 100 kg/hr. The discharge from the mixing unit went into the extruder unit which produces pellets. The extruder unit was at 190° C. The polymerization of the well mixed polymer/monomer melt took place in the extruder unit.

Pellets from the Farrel continuous mixer were converted to a 12 mil film on a standard polyolefin sheet casting line. The pellets extruded with no difficulty. The resulting film was examined for printability and water vapor transport. The results are shown in Table 9. The ability to take ink and to transport water vapor are desirable qualities for wall coverings.

TABLE 9

| | | water vapor transport |
|---|---|---|
| Sample | Print quality | g/100 in²/day |
| Farrel P/M dynamically | good | 39 |
| polymerized sample | | |
| Control made with no monomer | poor | 0.7 |

The acrylate functionality and resulting crosslink density of the dynamically vulcanized formulations of the invention raises the glass transition temperature, Tg, and the “rubber” modulus of the resulting thermoplastic vulcanizate, TPV, as demonstrated by Examples 7A through 7D wherein Finaplas 1571 grade syndiotactic polypropylene was charged to a laboratory batch scale Brabender mixing bowl followed by introduction and reaction or polymerization of acrylate monomers. The polypropylene polymer was charged to the bowl at 135° C. and 60 rpm, then the majority of the monomer was charged which resulted in a reduction of the torque value. Finally, the peroxide initiator was dispersed in the remainder of the monomer charge and was added and the bowl. Temperature and rotor speed were raised to 185° C. and 92 rpm, respectively, to perform the reaction.

Example 7A was a control and Examples 7B. 7C, and 7D were according to the invention, as set forth in Table 10.

TABLE 10

| | Example | | | |
|---|---|---|---|---|
| | 7A | | | |
| | (control) | | | |
| | No | 7B | 7C | 7D |
| | Acrylate | Monofunctional | Difunctional | Trifunctional |
| | No | Low Crosslink | Medium Crosslink | High Crosslink |
| | Peroxide | Density | Density | Density |
| Finaplas 1571 syndiotactic | 250.3 | 211.7 | 211.7 | 211.7 |
| PP | | 18.7 | | |
| SR-489 Tridecyl Acrylate | | 15.0 | | |
| SR-495 Caprolactone | | 3.7 | | |
| Acrylate | | | | |
| SR-344 | | | 37.4 | |
| Polyethyleneglycol | | | | 37.4 |
| Diacrylate | | | | |
| SR-9042 3PO | | 0.93 | 0.93 | 0.93 |
| Neopentylglycol | | | | |
| Diacrylate | | | | |
| SR-368D Triacrylate | | | | |
| Blend | | | | |
| Trigonox 301 Peroxide | | | | |
| Tg by DMA tan δ (° C.) | 12 | 16.5 | 29 | 31 |
| Rubber Modulus @ 0° C. | 1200 | 4750 | 3200 | 3950 |
| (Mpa) | | | | |

The experimental results reported in Table 10 show the invention increasing glass transition temperature and rubber modules versus the control polyolefin, with greater increases for higher functionality acrylate monomer systems.

While the invention has been described and illustrated in detail herein, various alternatives, modifications, and improvements should be readily apparent to those skilled in this art without departing from the spirit and scope of the invention. The present invention, therefore, is well adapted to carry out the objects and attain the ends and advantages mentioned, as well as others inherent therein. Although the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those of ordinary skill in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

1. A composition comprising a continuous polyolefin phase and a discontinuous nanoparticulate dispersion of a polymer of a monomer system comprising an acrylic monomer.

2. The composition of claim 1 wherein the discontinuous nanoparticulate dispersion comprises 1 to 99 parts by weight and the continuous polyolefin phase comprises 99 to 1 parts by weight, based on 100 parts of the total weight of the polyolefin and the dispersion.

3. The composition of claim 1, wherein the discontinuous nanoparticulate dispersion comprises about 5 to 50 parts by weight based on 100 parts of the total weight of the polyolefin and the dispersion.

4. The composition of claim 1 wherein the monomer system comprises one or more polyacrylate monomers.

5. The composition of claim 1 wherein the monomer system comprises one or more monomers selected from the group consisting of 2-(2-ethoxyethoxy) ethyl acrylate, diethylene glycol diacrylate, tridecyl acrylate, tridecylacrylate hexanediol diacrylate, lauryl acrylate, alkoxylated lauryl acrylate, caprolactone acrylate, 1,6-hexanediol diacrylate, trimethylolpropane triacrylate, polyethylene glycol diacrylate, neopentane diol diacrylate, and polyethylene glycol diacrylate.

6. The composition of claim 1 wherein the discontinuous nanoparticulate dispersion has an average particle size of about 2 to 500 nanometers.

7. The composition of claim 1 wherein the nanoparticulate dispersion has an average particle size of about 2 to 300 nanometers.

8. The composition of claim 1 having been prepared by introducing the polyolefin and the monomer system into a batch mixer, continuous mixer, single screw extruder, or twin screw extruder, forming a homogeneous mixture or solution, introducing a free radical catalyst, and providing pressure and temperature conditions so as to polymerize the monomer system and form a separate, dispersed nanoparticulate polymer phase in a continuous polyolefin phase.

9. The composition of claim 1 wherein the monomer system comprises tridecyl acrylate, caprolactone acrylate, and polyethylene glycol diacrylate.

10. The composition of claim 9 wherein the monomer system comprises 50% by weight tridecyl acrylate, 35-45% by weight caprolactone acrylate, and 5-15% by weight polyethylene glycol diacrylate.

11. The composition of claim 1 in the form of a fiber, wherein the fiber has improved dye pick up and resiliency properties as compared to the polyolefin which comprises the polyolefin phase.

12. The composition of claim 1 in the form of a fiber, sheet, film, or molded article having one or more improved properties selected from the group consisting of paintability, printability, biodegradability, wettability, tensile strength, impact strength, modulus, vapor transmission, thermoform processability, compatibility with fillers, compatibility in polymer blends, fire resistance, abrasion resistance, transparency, conductivity, and/or resistance to photodegredation as compared to the polyolefin which comprises the continuous polyoletin phase.

13. The composition of claim 1 having been prepared by reactive extrusion of the polyolefin and the monomer in the presence of a free radical catalyst.

14. The composition of claim 1 having been prepared by reactive extrusion of the polyolefin and the monomer in the presence of a peroxide catalyst.

15. The composition of claim 1 further comprising a filler.

16. The composition of claim 1 wherein the monomer system comprises an ethoxylated or propoxylated acrylate or methacrylate ester.

17. The composition of claim 1 wherein the polyolefin phase comprises two or more different polyolefins.

18. The composition of claim 1 wherein the polyolefin phase comprises at least one polyolefin selected from the group consisting of polyethylene (PE), isotactic polypropylene (PP), syndiotactic PP, ethylene-propylene copolymer (EP), and mixtures of PP and EP, propylene-ethylene-ethylene vinyl acetate copolymer, propylene-ethylene-ethylene methyl acrylate copolymer, and propylene-ethylene-ethylene acrylic acid copolymer.

19. The composition of claim 1 wherein the polyolefin phase comprises at least one metallocene polyolefin.

20. The composition of claim 1 wherein the polyolefin phase comprises at least one metallocene isotactic polypropylene homopolymer.

21. The composition of claim 1 wherein the polyolefin phase comprises at least one metallocene polypropylene random copolymer.

22. The composition of claim 1 wherein said polyolefin is a linear, branched or cyclic hydrocarbon having at least 10 carbon atoms.

23. The composition of claim 1 wherein the nanoparticulate dispersion comprises at least two different polymers of a monomer systems comprising an acrylic monomer, the different polymers having differing Tg's, different polarities, different moduluses, and/or different impact strengths.

24. A method comprising mixing or blending of a polyolefin and a monomer system comprising an acrylic monomer and polymerizing the monomer system in the presence of a free radical catalyst under conditions so as to form a discontinuous nanoparticulate dispersion in a continuous phase of the polyolefin.

25. The method of claim 24 wherein the mixing or blending and the polymerizing are conducted in a batch mixer, continuous mixer, single screw extruder, or twin screw extruder.

26. The method of claim 24 comprising mixing or blending one or more polyolefins.

27. The method of claim 24 further comprising mixing or blending the polyolefin and the monomer system in a weight ratio of about 98:2 to 50:50.

28. The method of claim 24 further comprising mixing or blending the polyolefin and the monomer system in a weight ratio of about 95:5 to 50:50.

29. The method of claim 24 wherein the monomer system comprises one or more monomers selected from the group consisting of 2-(2-ethoxyethoxy)ethyl acrylate, diethylene glycol diacrylate, tridecyl acrylate, tridecylacrylate hexanediol diacrylate, lauryl acrylate, alkoxylated lauryl acrylate, caprolactone acrylate, 1,6-hexanediol diacrylate, trimethylolpropane triacrylate, polyethylene glycol diacrylate, neopentane diol diacrylate, and polyethylene glycol diacrylate.

30. The method of claim 24 wherein the dispersion is a dispersed phase having an average particle size of about 2 to 500 nanometers.

31. The method of claim 24 wherein the dispersion is a dispersed phase having an average particle size of about 2 to 300 nanometers.

32. The method of claim 24 wherein the dispersion is a dispersed phase having an average particle size of less than 400 nanometers and a distribution such that at least 90 percent by weight of the particles being less than 50 nanometers.

33. The method of claim 24 further comprising forming a fiber having improved dye pick up and resiliency properties as compared to the polyolefin which comprises the polyolefin phase.

34. The method of claim 24 further comprising forming a fiber, sheet, film, or molded article having one or more improved properties selected from the group consisting of paintability, printability, biodegradability, wettability, tensile strength, impact strength, modulus, vapor transmission, thermoform processability, compatibility with fillers, compatibility in polymer blends, fire resistance, abrasion resistance, transparency, conductivity, and/or resistance to photodegredation as compared to the polyolefin which comprises the continuous polyolefin phase.

35. The method of claim 24 further comprising including a filler in the mixture or blend.

36. The method of claim 24 wherein the monomer system comprises at least one hydrophilic ethoxylated or propoxylated acrylate or methacrylate ester monomer.

37. The method of claim 24 wherein the continuous polyolefin phase comprises at least one polyolefin selected from the group consisting of polyethylene(PE), isotactic polypropylene (PP), syndiotactic PP, PE/PP, ethylene copolymers with alpha olefins, propylene copolymers with alpha olefins, and PP/EPR (ethylene-propylene rubber).

38. The method of claim 24 wherein the continuous polyolefin phase comprises at least one metallocene polyolefin selected from the group consisting of polyethylene(PE), isotactic polypropylene (PP), syndiotactic PP, PE/PP, ethylene copolymers with alpha olefins, propylene copolymers with alpha olefins, and PP/EPR (ethylene-propylene rubber).

39. The method of claim 24 wherein the continuous polyolefin phase comprises at least one metallocene isotactic polypropylene homopolymer.

40. The method of claim 24 wherein the continuous polyolefin phase comprises at least one metallocene polypropylene random copolymer.

41. The method of claim 24 wherein said polyolefin is a linear, branched or cyclic hydrocarbon having at least 10 carbon atoms.

42. A method of imparting improved properties to polyolefin compositions and articles comprising incorporating a uniformly dispersed nanoparticulate polymer in a continuous phase of the polyoletin.

43. Article having a composition according to claim 1 in the form of flooring having improved toughness and abrasion resistance.

44. Article having a composition according to claim 1 in the form of spun fiber, sheets, or automotive parts having improved printability, paintability, and dyeability.

45. Article having a composition according to claim 1 in the form of siding having improved impact strength.
